(19) United States
(12) Patent Application Publication
(10) Pub. No.: US 2001/0024481 A1
(43) Pub. Date: Sep. 27, 2001

(54) Direct-conversion demodulator having automatic-gain-control function

(76) Inventor: Heung-bae Lee, Suwon-city (KR)

Correspondence Address: SUGHRUE, MION, ZINN, MACPEAK & SEAS, PLLC, 2100 Pennsylvania Avenue, N.W., WASHINGTON, DC, 20037-3202, US

(21) Appl. No.: 09/738,900

(22) Filed: Dec. 18, 2000

(30) Foreign Application Priority Data
Dec. 18, 1999 (KR) 99-58926

(51) Int. Cl. H04L 27/08

(52) U.S. Cl. 375/345; 375/316; 455/234.1

(57) ABSTRACT

A direct-conversion demodulator having an automatic-gain-control (AGC) function is provided. A down mixer mixes a received RF signal and carrier signals so that a phase difference between the received RF signal and carrier signals may be 90°, and thereby converting the RF signal into baseband signals of channels I and Q having a phase difference of 90°. A filter filters high-frequency components of the outputs from the down mixer. A detector detects a gain control level corresponding to the difference obtained by comparing the levels of the filter outputs with a predetermined level. An AGC controls the gains of the outputs from the down mixer according to the gain control level detected by the detector. A differentiator differentiates the outputs from the filter. A multiplier cross multiplies the outputs from the differentiator and the outputs from the filter. An adder adds the outputs of the multiplier and thereby detects data.

### BACKGROUND OF THE INVENTION

1. Field of the Invention

The present invention relates to a radio communication system, and more particularly, to a direct-conversion demodulator having an automatic-gain-control (hereinafter referred to as AGC) function. The present application is based on KPA 99-58926, which is incorporated herein by reference.

2. Description of the Related Art

In general, a transmitter is required to transmit data as a radio frequency (RF) signal after modulating the data into a frequency shift keying (FSK), and a receiver is required to demodulate the RF signal received from an antenna (not shown) for radio communication. In demodulation, a direct-conversion system provides baseband signals by multiplying a received RF signal by carrier signals of channels I (inphase) and Q (quadrature).

FIG. 1 shows a typical FSK direct-conversion radio demodulator.

Referring to FIG. 1, first and second down mixers 112 and 114 mix the received RF signal and carrier signals so that a phase difference between the received RF signal and carrier signals may be 90°, and thereby convert the RF signal into baseband signals of channels I and Q having a phase difference of 90°. For example, a baseband signal of channel I is referred to as SinWct, and a baseband signal of channel Q is referred to as CosWct. First and second amplifiers 122 and 124 amplify the baseband signals of channels I and Q, respectively, which are converted by the first and second down mixers 112 and 114, respectively. First and second low pass filters (LPF) 132 and 134 remove noise by filtering the baseband signals of channels I and Q, respectively, amplified by the first and second amplifiers 122 and 124. First and second differentiators 142 and 144 differentiate the baseband signals of channels I and Q, respectively, filtered by the first and second LPFs 132 and 134, and the baseband signals of channels I and Q are thereby led by 90°. At this time, the first differentiator 142 outputs WcCosWct, and the second differentiator 144 outputs −WcSinWct. First and second multipliers 152 and 154 cross multiply the baseband signals of channels I and Q differentiated by the first and second differentiators 142 and 144 and the baseband signals of the channels filtered by the first and second LPFs 132 and 134. Accordingly, the first and second multipliers 152 and 154 generate WcCos2Wct and WcSin2Wct, respectively. An adder 162 adds the baseband signals of two channels multiplied by the first and second multipliers 152 and 154 and thereby detects only data Wc.

In a radio demodulator as shown in FIG. 1, the level of the RF signal received from the antenna is generally in the range of −70 dBm˜OdBm. Here, in a case where the level of the received RF signal is small, since a signal down-mixed by the first and second down mixers 112 and 114 is small, a signal amplified by the first and second amplifiers 122 and 124 is not clipped. However, in a case where the level of the received RF signal is large, since the signal down-mixed by the first and second down mixers 112 and 114 is large, it is easy for the signal amplified by the first and second amplifiers 122 and 124 to be clipped. In this case, it is not easy to detect a signal through the first and second differentiators 142 and 144 and the first and second multipliers 152 and 154 due to distortion of the RF signal by a clipping phenomenon. Thus, it is easy for the adder 162 to incorrectly detect data.

### SUMMARY OF THE INVENTION

To solve the above problems, it is an object of the present invention to provide a direct-conversion demodulator capable of maintaining the level of a signal output therefrom to be constant by including therein an AGC loop, in which the level of a received RF signal is automatically maintained in a direct-conversion radio receiver.

Accordingly, to achieve the above object, there is provided a direct-conversion demodulator in an RF reception system for radio communication. The direct-conversion demodulator includes a down mixer, a filter, a detector, an AGC, a differentiator, a multiplier, and an adder. The down mixer mixes the received RF signal and carrier signals so that a phase difference between the received RF signal and carrier signals may be 90°, and thereby convert the RF signal into baseband signals of channels I and Q having a phase difference of 90°. The filter filters high-frequency components of the baseband signals of the two channels output from the down mixer. The detector detects a gain control level, which corresponds to the difference obtained by comparing the levels of the baseband signals of the two channels detected by the filter with a predetermined level. The AGC controls the gains of the baseband signals for each of the two channels output from the down mixer according to the gain control level detected by the detector. The differentiator differentiates the baseband signals of the two channels output from the filter. The multiplier cross multiplies the baseband signals of the two channels output from the differentiator and the baseband signals of the two channels output from the filter. The adder adds the baseband signals of the two channels multiplied by the multiplier and thereby detects data.

### BRIEF DESCRIPTION OF THE DRAWINGS

The above object and advantages of the present invention will become more apparent by describing in detail preferred embodiments thereof with reference to the attached drawings in which:

FIG. 1 shows a typical direct-conversion radio receiver.

FIG. 2 is a block diagram illustrating a direct-conversion demodulator having an AGC function according to the present invention.

FIG. 3 is a detailed diagram of the AGC detector shown in FIG. 2.

FIG. 4 is a detailed diagram of the first and second multipliers 310 and 320 shown in FIG. 3.

FIG. 5 is a detailed diagram of the adder 330 shown in FIG. 3; and

FIG. 6 is a detailed diagram of the level comparator 340 shown in FIG. 3.

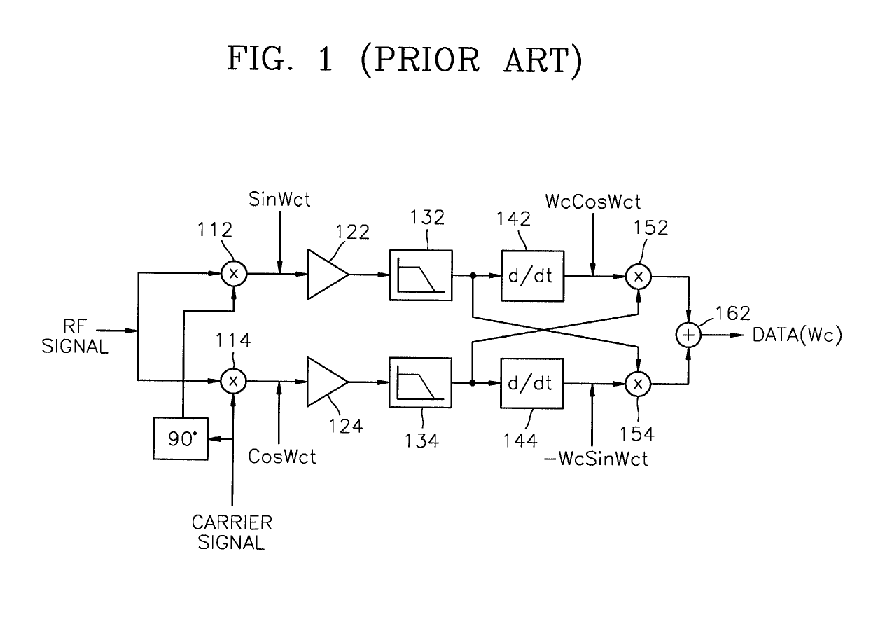

### DETAILED DESCRIPTION OF THE INVENTION

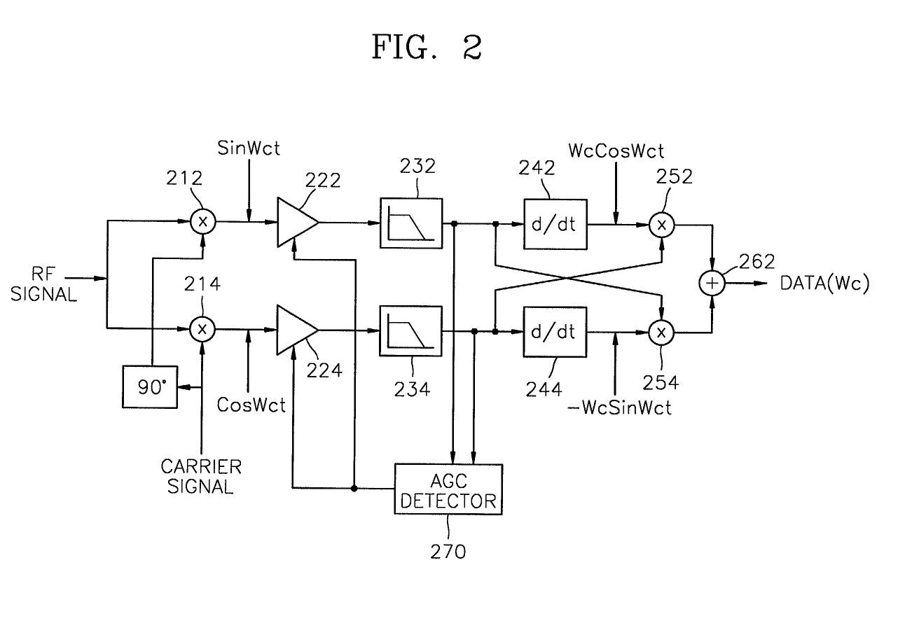

Referring to FIG. 2, a direct-conversion demodulator having an AGC function according to an embodiment of the present invention is shown. The apparatus shown in FIG. 2 sequentially includes first and second down mixers 212 and 214, first and second AGCs 222 and 224, first and second LPFs 232 and 234, first and second differentiators 242 and 244, first and second multipliers 252 and 254, and an adder 262, and an AGC detector 270 is connected to the outputs of the first and second LPFs 232 and 234 and control terminals of the first and second AGCs 222 and 224.

With reference to FIG. 2, the first and second down mixers 212 and 214 mix a received RF signal and carrier signals so that a phase difference between the received RF signal and carrier signals may be 90°, and thereby convert the RF signal into baseband signals of channels I and Q, respectively. For example, the first down mixer 212 outputs SinWct, a channel I signal, and the second down mixer outputs CosWct, a channel Q signal.

The first and second AGCs 222 and 224 automatically control the gains of the baseband signals SinWct and CosWct of the channels I and Q converted by the first and second down mixers 212 and 214 according to an AGC control level input into the terminals (not shown) of the first and second AGCs 222 and 224.

The first and second LPFs 232 and 234 output the baseband signals of each channel, from which noise components have been removed by filtering high-frequency components of the baseband signals SinWct and CosWct of the channels I and Q gain-controlled by the first and second AGCs 222 and 224.

The AGC detector 270 automatically controls gain by outputting an AGC control level, which corresponds to the difference obtained by comparing the levels of the baseband signals SinWct and CosWct of the channels I and Q filtered by the first and second LPFs 232 and 234 with a predetermined level, to the control terminals (not shown) of the first and second AGCs 222 and 224.

The first and second differentiators 242 and 244 differentiate the baseband signals SinWct and CosWct of the channels I and Q filtered by the first and second LPFs 232 and 234, respectively, and the baseband signals of channels I and Q are thereby led by 90°. The first differentiator 242 outputs a signal WcCosWct, and the second differentiator 244 outputs a signal −WcSinWct. The first and second multipliers 252 and 254 cross multiply signals WcCosWct and −WcSinWct differentiated by the first and second differentiators 242 and 244 and the baseband signals of the channels I and Q filtered by the first and second LPFs 232 and 234. Accordingly, the first and second multipliers 252 and 254 generate WcCos2Wct and −WcSin2Wct, respectively.

An adder 262 adds the signals WcCos2Wct and −WcSin2Wct of the two channels multiplied by the first and second multipliers 252 and 254 and thereby detects only data Wc.

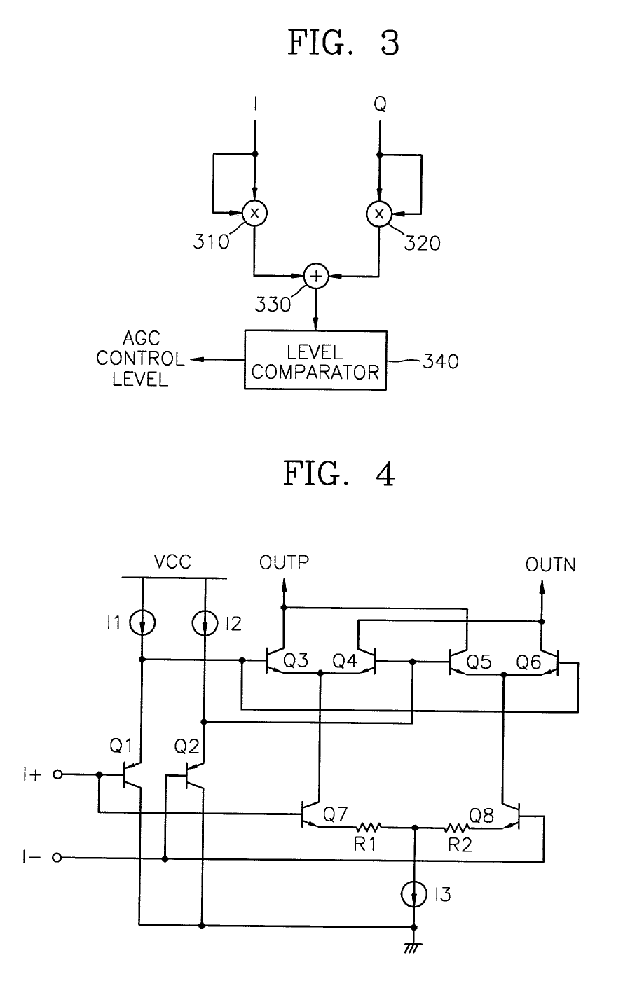

Referring to FIG. 3, which illustrates the AGC detector shown in FIG. 2 according to the present invention, the AGC detector is constructed of two multipliers 310 and 320, an adder 330, and a level comparator 340.

With reference to FIG. 3, the first and second multipliers 310 and 320 multiply each of the baseband signals SinWct and CosWct of channels I and Q, respectively, by itself. The adder 330 adds the signals multiplied by the first and second multipliers 310 and 320 and thereby detects the levels of the signals for each of the channels I and Q. The level comparator 340 generates an AGC control level corresponding to the difference obtained by comparing the levels of the signals for each of the channels I and Q being detected by the adder 330 with a predetermined comparison level. Accordingly, the gains of the first and second AGCs 222 and 224 are controlled by the AGC control level.

Referring to FIG. 4, which illustrates first and second multipliers 310 and 320 shown in FIG. 3 according to the present invention, the first and second multipliers are constructed to have the structure of a Gilbert multiplier.

Taking only the channel I as an example, baseband signals I+ and I− of channel I, which are differentially-input, are level-shifted via transistors Q1 and Q2 and the baseband signals I+ and I− of channel I are supplied to cross-coupled pairs Q3, Q4, Q5, and Q6, and simultaneously, the baseband signals I+ and I− of channel I are supplied to emitter-coupled pair Q7 and Q8. Accordingly, the multipliers of FIG. 4 multiply differentially-amplified signals in the cross-coupled pairs and the emitter-coupled pair and thereby output the signals in the form of a differential current.

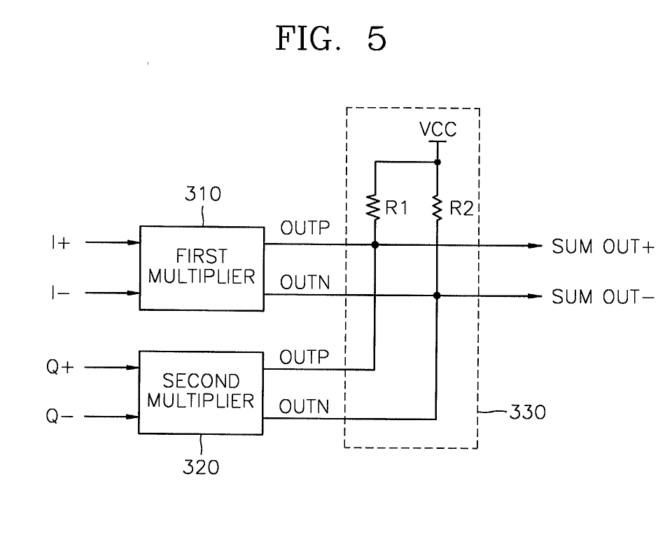

Referring to FIG. 5, which illustrates the adder 330 shown in FIG. 3 according to the present invention, each of output signals OUTP and OUTN output from the first and second multipliers 310 and 320, which multiply the baseband signal of the channel I with the channel I− and the channel Q with the channel Q−, is connected to the adder 330 constructed of load resistances R1 and R2. The adder 330 adds each of the output signals OUTP and OUTN output in the form of a current from the first and second multipliers 310 and 320 and thereby converts the same into a differential output voltage.

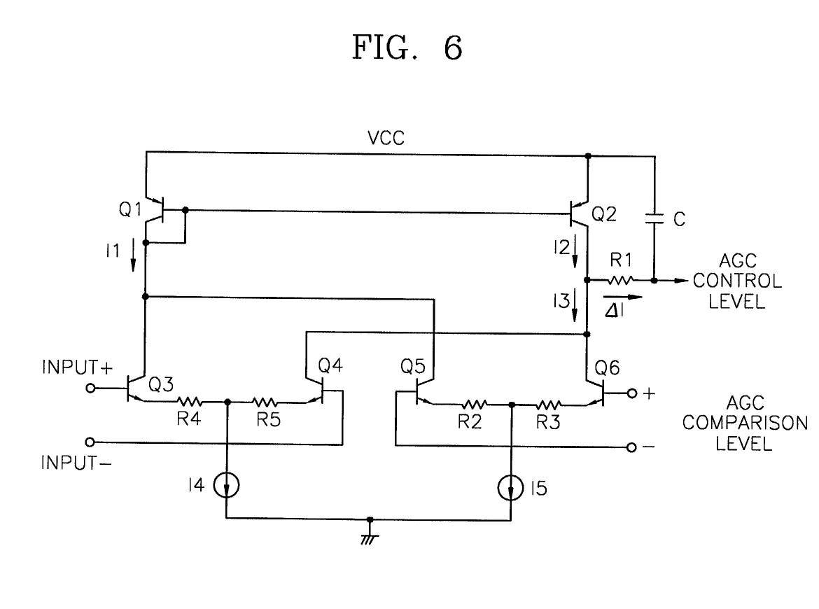

Referring to FIG. 6 illustrating a level comparator 340 shown in FIG. 3 according to the present invention, the level comparator 340 receives the level of the signal output from the adder 330 by constructing a first differential amplifier of resistances R4 and R5 and transistors Q3 and Q4, and receives a predetermined AGC comparison level by constructing a second differential amplifier of resistances R2 and R3 and transistors Q5 and Q6. The first and second differential amplifiers generate a current ΔI corresponding to the difference obtained by comparing the level of the RF signal received from the adder 330 with an AGC comparison level. The current Δ1 is converted into the AGC control level by passing it through a resistance R1 and a capacitance C. For example, in a case where the AGC comparison level is set to 500 mV, if the level of the RF signal is greater than 500 mV, a current I1 is increased to be greater than a current I3, and a current I2 is increased by transistors Q1 and Q2 corresponding to a current mirror. If ΔI is increased according to an increase of the current 12, the AGC control level is increased. To the contrary, if the level of the RF signal is less than 500 mV, the current I1 is decreased to be less than the current I3, and as a consequence, ΔI is decreased, and the AGC control level is decreased.

Finally, in the case where the level of the RF signal is large, the AGC control level is increased. Also, an increased AGC control level decreases the gain of the first and second AGCs 222 and 224 and thereby maintains the output signal at a constant level.

The present invention is not restricted to the embodiments described above, and it will be understood by one skilled in the art that further modifications are possible without departing from the spirit and scope of the invention. That is, the present invention is applicable to a radio communication system using industry, science, and medical (ISM) band of 2.4 GHz, and it is applicable to a wireless local area network (LAN) and home network etc. using the FSK modulator-demodulator regardless of a band frequency.

As described above, according to the present invention, the output signal is automatically maintained at a constant level by constructing the AGC loop, and in a case where the level of the input RF signal is large, the level is detected, and the gains of the AGC amplifier are decreased, thereby preventing distortion of demodulated signals and enabling the stable detection of data.

What is claimed is:

1. A direct-conversion demodulator in a RF reception system for radio communication comprising:
a down mixer for mixing a received RF signal and carrier signals so that a phase difference between the received RF signal and carrier signals may be 90°, and thereby converting the RF signal into baseband signals of channels I and Q having a phase difference of 90°;
a filter for filtering high-frequency components of the baseband signals of the two channels output from the down mixer;
a detector for detecting a gain control level corresponding to a difference obtained by comparing levels of the baseband signals of the two channels detected by the filter with a predetermined level;
an AGC for controlling gains of the baseband signals for each of the two channels output from the down mixer according to the gain control level detected by the detector;
a differentiator for differentiating the baseband signals of the two channels output from the filter;
a multiplier for cross multiplying the baseband signals of the two channels output from the differentiator and the baseband signals of the two channels output from the filter; and
an adder for adding the baseband signals of the two channels multiplied by the multiplier and thereby detecting data.

2. The direct-conversion demodulator according to claim 1, wherein the detector comprises:
a multiplying unit for multiplying the baseband signals of the two channels with themselves;
an adding unit for adding the baseband signals of the two channels multiplied by the multiplying unit and thereby detecting the levels of each of the signals; and
a level-comparing unit for generating a gain control level corresponding to the difference obtained by comparing the levels of the signals detected by the adding unit with a predetermined level.
